(19) United States
(12) Patent Application Publication
(10) Pub. No.: US 2017/0328315 A1
(43) Pub. Date: Nov. 16, 2017

(54) AIR FILTER FOR AN ENGINE

(71) Applicant: Briggs & Stratton Corporation, Wauwatosa, WI (US)

(72) Inventors: Ryan Sullivan, West Bend, WI (US); Brian Paul, Wauwatosa, WI (US); Matt Martinek, Cedarburg, WI (US); Jason Heinrich, Wauwatosa, WI (US)

(73) Assignee: Briggs & Stratton Corporation, Wauwatosa, WI (US)

(21) Appl. No.: 15/152,709

(22) Filed: May 12, 2016

(51) Int. Cl. F02M 35/024; B01D 46/52; B01D 46/00

(52) U.S. Cl. CPC F02M 35/02416; F02M 35/02483; B01D 46/525; B01D 46/001; B01D 46/0043; B01D 46/523

(57) ABSTRACT

An air filter is provided for use with an internal combustion engine including an air intake conduit. The air filter includes a top, a bottom, and filter media extending between the top and the base of the bottom to filter incoming air. The top is closed to prevent air flow therethrough. The bottom includes an annular base having an inner perimeter and an outer perimeter spaced apart from and surrounding the inner perimeter, an opening defined by the inner perimeter to deliver filtered air to the air intake conduit, a first tab portion extending outward away from the base, and a second tab portion extending outward away from the base.

### BACKGROUND

The present application generally relates to the field of air filters for use with internal combustion engines. An internal combustion engine typically includes an air filter for removing dust, dirt, or other debris from air entering the engine for combustion processes. The air filter may include filter media, such as filter paper, foam, mesh, or other media. Removing the debris from the air helps to preserve the moving components of the engine, such as the piston and crankshaft, avoiding excess friction and wear, as well as preventing clogging of the fuel delivery system.

### SUMMARY

One embodiment of the invention relates to an air filter for use with an internal combustion engine including an air intake conduit. The air filter includes a top, a bottom, and filter media extending between the top and the base of the bottom to filter incoming air. The top is closed to prevent air flow therethrough. The bottom includes an annular base having an inner perimeter and an outer perimeter spaced apart from and surrounding the inner perimeter, an opening defined by the inner perimeter to deliver filtered air to the air intake conduit, a first tab portion extending outward away from the base, and a second tab portion extending outward away from the base.

Another embodiment of the invention relates to an air filter for use with an internal combustion engine including an air intake conduit. The air filter includes a top, a bottom, and filter media extending between the top and the base of the bottom to filter incoming air. The top is closed to prevent air flow therethrough. The bottom includes an outer perimeter, a first tab portion extending outward away from the outer perimeter, a second tab portion extending outward away from the outer perimeter, and an opening to deliver filtered air to the air intake conduit.

Another embodiment of the invention relates to an air filter assembly for use with an internal combustion engine including an air intake conduit. The air filter assembly includes an air filter housing and an air filter. The air filter housing includes a cover, a base, wherein the cover and the base define an interior volume, wherein the base includes an air inlet through which incoming air is configured to enter the interior volume and an air outlet through which filtered air is configured to exit the interior volume, multiple debris openings formed through the base, and a deflector positioned between the air inlet and the air outlet, the deflector configured to direct the flow of incoming air within the interior volume toward the debris openings to allow particulate matter to fall out of the flow of incoming air and exit the interior volume through the debris openings. The air filter is positioned within the interior volume and configured to filter the incoming air to produce filtered air, wherein the air filter includes a top that is closed to prevent air flow therethrough, a bottom including a first outward extending tab portion, a second outward extending tab portion, and an opening configured to deliver filtered air to the air outlet.

Another embodiment of the invention relates to an air filter assembly for use with an internal combustion engine including an air intake conduit. The air filter assembly includes an air filter housing and an air filter. The air filter housing includes a cover, a base, wherein the cover and the base define an interior volume, wherein the base includes an air inlet through which incoming air is configured to enter the interior volume and an air outlet through which filtered air is configured to exit the interior volume, a first clamp, and a second clamp. The air filter is positioned within the interior volume and configured to filter the incoming air to produce filtered air, wherein the air filter includes a top that is closed to prevent air flow therethrough, a bottom including a first outward extending tab portion, a second outward extending tab portion, and an opening configured to deliver filtered air to the air outlet. The first clamp contacts the first outward extending tab portion and the second clamp contacts the second outward extending tab portion to attach the air filter to the base.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, in which:

FIG. 1 is a perspective view of an internal combustion engine according to an exemplary embodiment of the invention;

FIG. 2 is a perspective view of the engine of FIG. 1 with an air filter cover removed;

FIG. 3 is a perspective view of the engine of FIG. 2 with an air filter removed;

FIG. 4 is a top view of the engine of FIG. 2;

FIG. 5 is a top view of the engine of FIG. 2 with an air filter removed;

FIG. 6 is a section view of the engine of FIG. 4 taken along line 6-6;

FIG. 7 is a section view of the engine of FIG. 5 taken along line 7-7;

FIG. 8 is a front view of the engine of FIG. 3 with the air filter removed;

FIG. 9 is a front view of the engine of FIG. 2;

FIG. 10 is a section view of a portion of the engine of FIG. 1;

FIG. 11 is a perspective view from above of the air filter of FIG. 2;

FIG. 12 is a front view of the air filter of FIG. 11;

FIG. 13 is a left side view of the air filter of FIG. 11;

FIG. 14 is a top view of the air filter of FIG. 11;

FIG. 15 is a bottom view of the air filter of FIG. 11; and

FIG. 16 is a perspective view from below of the air filter of FIG. 11.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

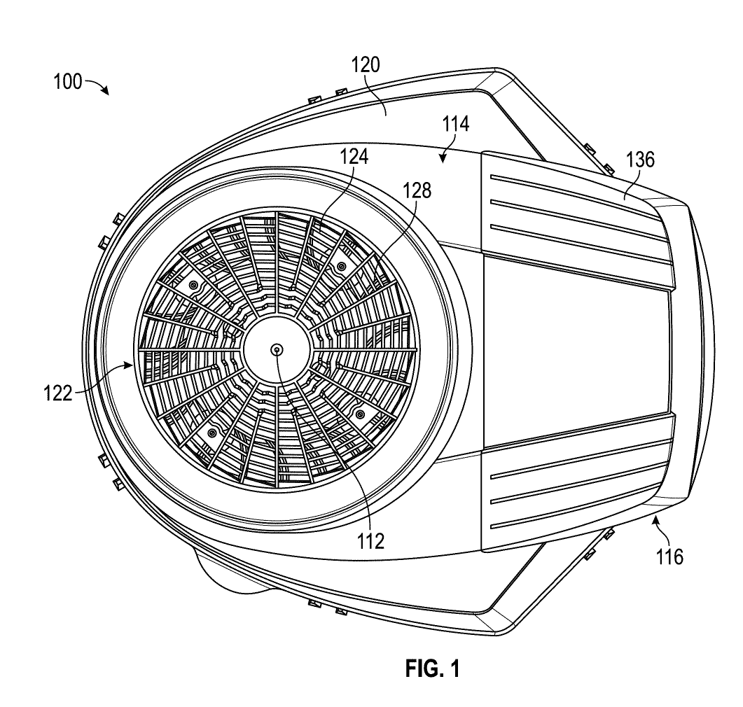

Referring to FIG. 1, an internal combustion engine 100 is shown according to an exemplary embodiment. The engine may be used in outdoor power equipment, standby generators, portable jobsite equipment, or other appropriate uses. Outdoor power equipment includes lawn mowers, riding tractors, snow throwers, pressure washers, portable generators, tillers, log splitters, zero-turn radius mowers, walk-behind mowers, riding mowers, industrial vehicles such as forklifts, utility vehicles, etc. Outdoor power equipment may, for example, use an internal combustion engine to drive an implement, such as a rotary blade of a lawn mower, a pump of a pressure washer, the auger a snow thrower, the alternator of a generator, and/or a drivetrain of the outdoor power equipment. Portable jobsite equipment includes portable light towers, mobile industrial heaters, and portable light stands.

The engine 100 includes an engine block having a cylinder, a piston, a cylinder head, and a crankshaft. The piston reciprocates in the cylinder to drive the crankshaft. The crankshaft rotates about a crankshaft axis 112. As illustrated, the engine 100 includes two cylinders arranged in a V-twin configuration. In other embodiments, the engine includes a single cylinder. In other embodiments, the engine includes two or more cylinders that can be arranged in different configurations (e.g., inline, horizontally opposed, etc.). In some embodiments, the engine 100 is vertically shafted as illustrated, while in other embodiments, the engine is horizontally shafted.

The engine 100 also includes a blower assembly 114, an air filter assembly or air cleaner 116, and a carburetor or other air-fuel mixing device (e.g., an electronic fuel injection system, a fuel direct injection system, etc.). The blower assembly 114 includes a blower housing 120 (e.g., engine cover, engine shroud, etc.) having an opening 122. The blower housing 120 may be formed from one or more components and forms a shroud for at least a portion of the engine block so that an internal volume is formed between the housing 120 and the engine block. A screen 124 defining air inlets covers the opening 122. The blower assembly 114 also includes a blower fan 128. In some embodiments, the fan 128 is coupled to a flywheel attached to the crankshaft and rotates about the crankshaft axis 112. In some embodiments, the fan 128 is driven independently from the crankshaft (e.g., by an electric motor). Rotation of the fan 128 draws air in through the air inlets in the screen 124 and into the internal volume defined in part by the blower housing 120. Some of this air is directed to the air filter assembly 116 for eventual use in combustion and some of this air is used to cool the engine.

The air filter assembly 116 includes an air filter 130 and an air filter housing having a base 134 and a cover 136. The air filter housing may be an integral component of the blower housing 120 or separate component attached to the blower housing 120. In some embodiments, the base 134 and the cover 136 are formed (e.g., molded) from a plastic material. In other embodiments, at least one of the base 134 and the cover 136 is formed from other materials (e.g., aluminum, steel, etc.).

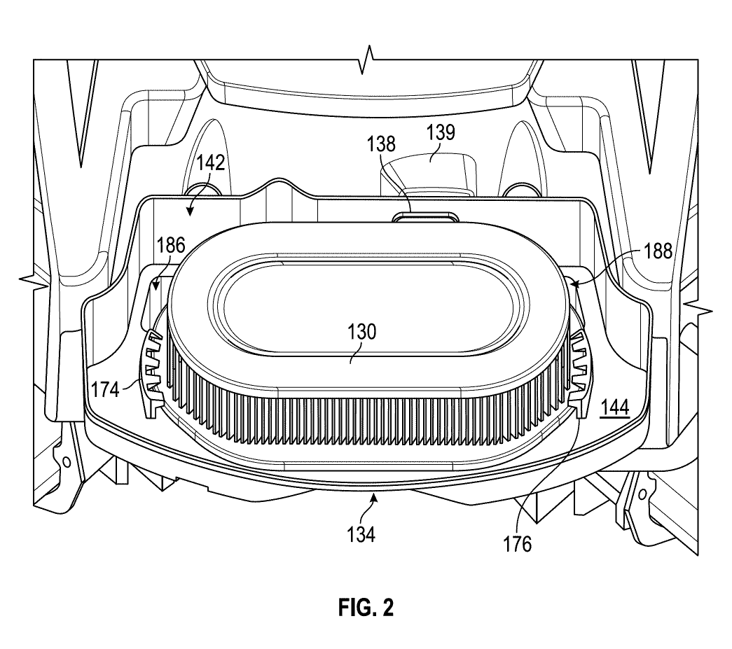

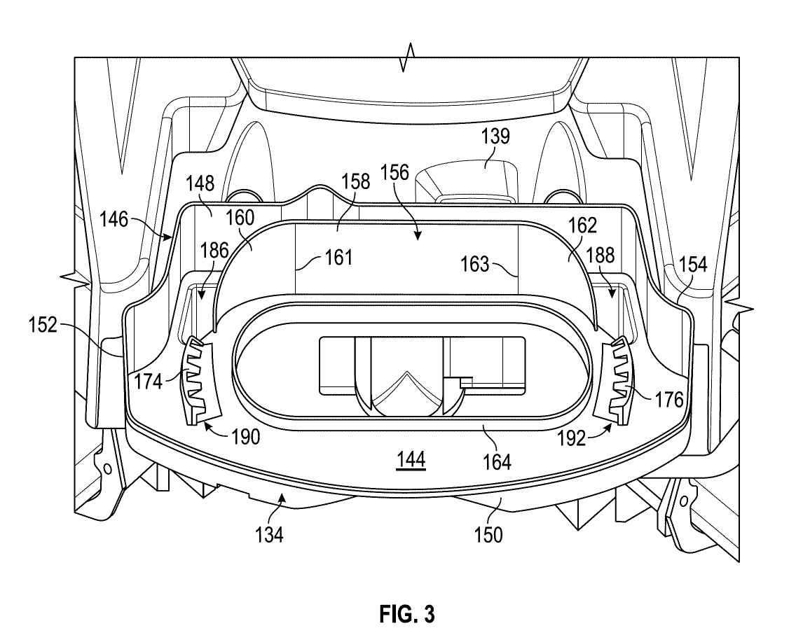

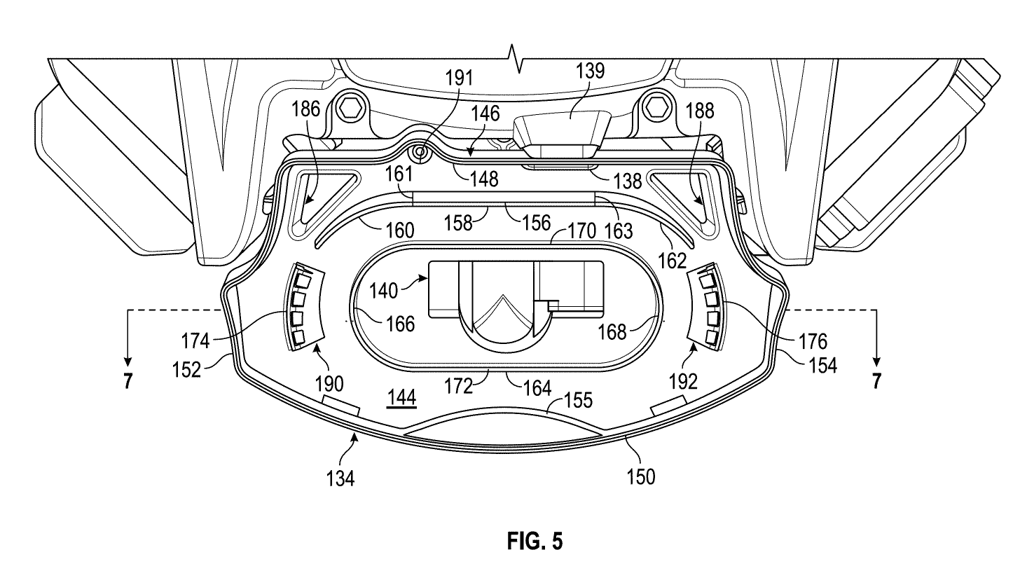

With reference to FIGS. 2-5, the air filter housing includes an air inlet 138 for receiving air from an air outlet 139 of the blower assembly 114 (“incoming air” or “unfiltered air”) and an air outlet 140 (FIG. 3) for providing air to the carburetor (“filtered air”). The base 134 and the cover 136 define an interior volume 142. The air filter 130 is positioned within the interior volume 142 between the air inlet 138 and the air outlet 140 in terms of air flow so that unfiltered air passes through and is filtered by the air filter 130 resulting in filtered air. In some embodiments, the base 134 and the cover 136 are releaseably attached to one another with snap-fit fasteners, removable fasteners (e.g., threaded bolts), or other suitable fasteners. In some embodiments, the cover 136 is attached to the base 134 by a hinge and is secured in a closed position by a latch or other suitable fasteners.

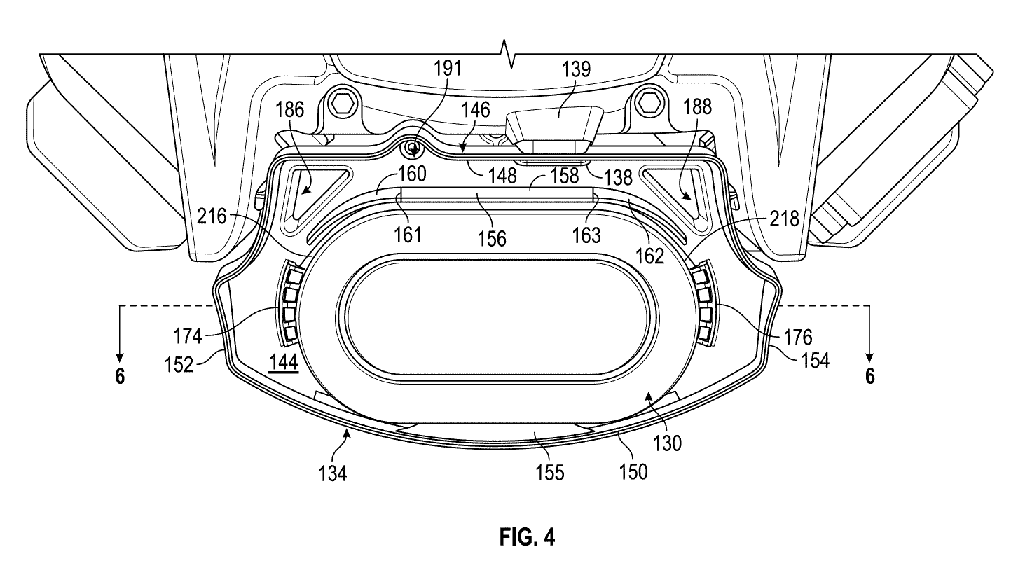

With reference to FIG. 4, the base 134 includes a floor or bottom wall 144 and an outer wall 146 that extends away from the floor 144 and is located at the periphery of the floor 144 to define a portion of the interior volume 142. The outer wall 146 includes a rear portion 148 (rear wall, first portion), a front portion 150 (front wall, second portion), a left side portion 152 (left side wall, third portion), and a right side portion 154 (right side wall, fourth portion). In some embodiments, as illustrated, the air inlet 138 is formed through the outer wall 146 and the air outlet 140 is formed in the floor 144. The front portion 150 includes a protrusion 155 that extends toward the rear portion 148. In some embodiments, as illustrated, the air outlet 140 is positioned at or near the center of the floor 144. An air intake conduit 141 extends between the air outlet 140 and the carburetor to provide filtered air to the carburetor.

A deflector, baffle, or wall 156 extending away from the floor 144 is positioned between the air inlet 138 and the air outlet 140 to impinge on the incoming air flow from the air inlet 138 and direct the flow of unfiltered air from the air inlet 138 to the air outlet 140 via a circuitous path. The wall 156 includes a central portion 158 and two end portions 160 and 162. The end portions 160 and 162 are not parallel to the central portion 158 (e.g., curved or angled relative to the central portion 158) to change the direction of the flow of unfiltered air as it moves from the central portion 158 to one of the end portions 160 and 162. The direction of each end portion 160 and 162 relative to the central portion 158 changes at a transition 161 and 163, respectively. The transition is where the direction of the wall changes. For example, the transition may be the change from a straight segment or line to a curved segment or line, the transition may be the change from a first curvilinear segment or line having a first radius of curvature to a second curvilinear segment or line having a different radius of curvature, the transition may be the change from a first straight segment to a second straight segment arranged at an angle to the first straight segment. The transition may be a line (e.g., a straight vertical line) or an area (e.g., a fillet, bevel, or chamfer connecting two segments).

A protrusion or filter attachment member 164 extends away from the floor 144 and attaches the air filter 130 to the base 134. The protrusion 164 includes two end portions 166 and 168 and two side portions 170 and 172 connecting the end portions 166 and 168. As illustrated, in some embodiments, the end portions 166 and 168 are curvilinear and the side portions 170 and 172 are straight. Curvilinear end portions include the semi-circular end portions as illustrated and other shapes, including but not limited to, a portion of a circle, a portion of an oval, a portion of an ellipse, and arcuate. The shape of the protrusion 164 may be different in other embodiments (e.g., a rectangle with rounded corners, an oval, a circle, etc.). The protrusion 164 surrounds the air outlet 140. As shown in FIG. 3, the protrusion 164 extends away from the floor 144 to a height less than the height of the central portion 158 of the wall 156. The height of the end portions 160 and 162 decrease as the end portions 160 and 162 extend away from the central portion 158. In some embodiments, the protrusion 164 is omitted from the base 134.

Two attachment arms or clamps 174 and 176 at least partially attach the air filter 130 to the base 134. The left side or first clamp 174 includes a base 178 that extends away from the floor 144 and a projection or finger 180 that extends from the base 178 toward the center of the floor 144 to a distance 181. The finger 180 is spaced apart from the floor 144 by a height 183. As illustrated, the clamp 174 is substantially L-shaped with a portion of the finger 180 overhanging the base 178. The right side or second clamp 176 includes a base 182 and a projection or finger 184 arranged in a manner similar to those of the clamp 174 with the finger 184 extending away from the base 182 to a distance 185 and spaced apart from the floor 144 by a height 187. In some embodiments, only one clamp is present. In some embodiments, more than two clamps are present. In some embodiments, the protrusion 164 is the primary attachment connection securing the air filter 130 to the base 134 and the clamps 174 and 176 are the secondary attachment connection and at least partially attach the air filter 130 to the base 134. In some embodiments, the clamps 174 and 176 are the primary attachment connection securing the air filter 130 to the base 134 and the protrusion 164 is the secondary attachment connection and at least partially attach the air filter 130 to the base 134. In some embodiments, the clamps 174 and 176 are omitted and the protrusion 164 is the only attachment connection securing the air filter 130 to the base 134. In some embodiments, the protrusion 164 is omitted and the clamps 174 and 176 are the only attachment connection securing the air filter 130 to the base 134.

Apertures or openings 186 and 188 are formed through the floor 144 to allow particulate matter (e.g., dust, debris, lawn clippings, etc.) to exit the air filter assembly 116. Conduits may extend downward from the openings 186 and 188 in the floor 144 to direct particulate matter away from the air filter housing 132. Opening 186 is located near the corner formed by the rear portion 148 and the left side portion 152 of the outer wall 146. Opening 188 is located near the corner formed by the rear portion 148 and the right side portion 154 of the outer wall 146. Opening 190 is located near the base 178 of the left side clamp 174. Opening 192 is located near the base 182 of the right side clamp 176. Opening 191 is formed through the floor 144 to allow access for a user to adjust the idle screw of the carburetor 118.

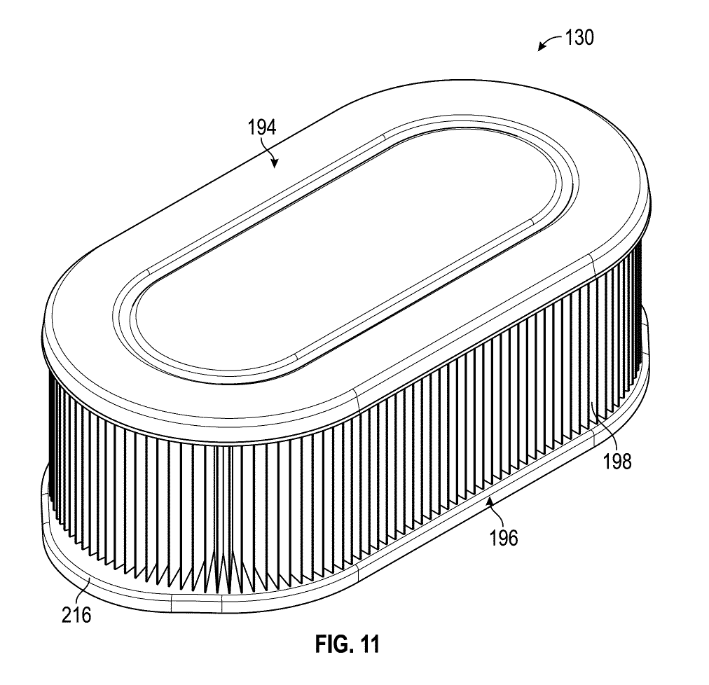

As shown in FIGS. 11-16, the air filter or filter element 130 includes a top or first wall 194, a bottom or second wall 196, and filter media 198 extending between the top and bottom walls. The top 194, the bottom 196, and the filter media 198 define an interior chamber 200 of the air filter 130. In some embodiments, the top 194 and the bottom 196 are formed from a rigid material (e.g., plastic, cardboard, etc.). As illustrated, in some embodiments, the filter media 198 is pleated filter paper, while in other embodiment other forms of filter media (e.g., foam, polymer, fiberglass, non-woven filter material, etc.) are used.

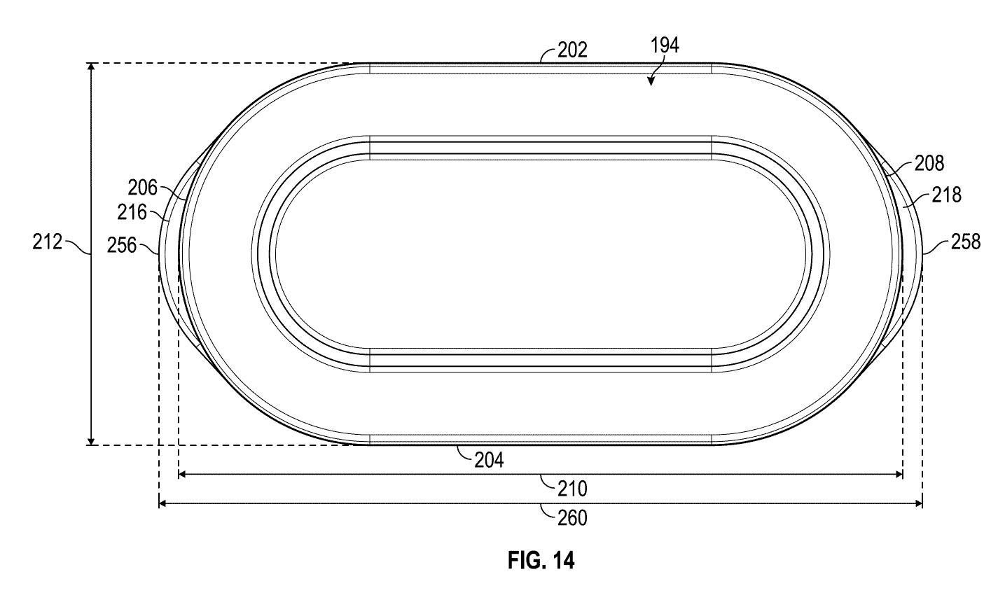

As shown in FIG. 14, the top 194 is a closed wall that prevents air flow therethrough. The top 194 includes a first side portion 202, a second side portion 204, a first end portion 206, and a second end portion 208. In some embodiments, as illustrated, the first side portion 202 and the second side portion 204 extend for a distance 210 between the first end portion 206 and the second end portion 208 (e.g., length) that is greater than the distance 212 (e.g. width) between the first side portion 202 and the second side portion 204. The first side portion 202 and the second side portion 204 are straight and the first end portion 206 and the second end portion 208 are curvilinear (e.g., semi-circular as illustrated). In other embodiments, the top 194 has a different shape (e.g., square, rectangle, other polygon, circle, oval, ellipse, etc.).

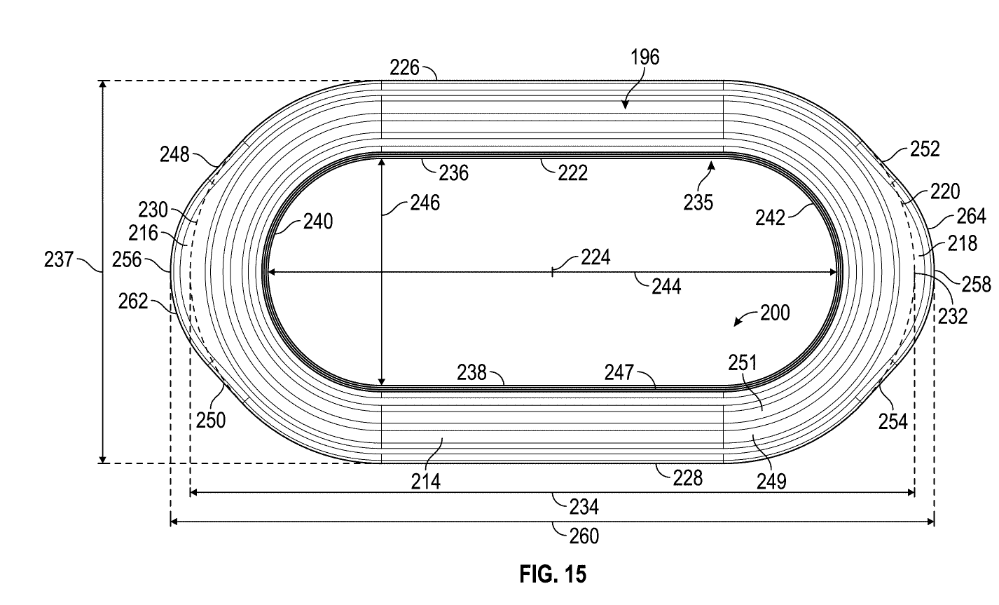

As shown in FIG. 15, the bottom 196 includes an annular or ring-shaped base 214 and two protrusions or tab portions 216 and 218 that extend outward away from the base 214. The annular base 214 may be formed in many different shapes (e.g., straight sides with curvilinear ends as illustrated, square, rectangle, other polygon, circle, oval, ellipse, racetrack, etc.). In some embodiments, as illustrated, the bottom 196, including the base 214 and the tab portions 216 and 218, is a single integrally formed component (e.g., a molded polymer wall). The base 214 has an outer perimeter 220 and an inner perimeter 222. The outer perimeter 220 is spaced apart from and surrounds the inner perimeter 222 and the outer perimeter 220 and the inner perimeter 222 are concentric (i.e., centered) about a vertical center axis 224 that extends through the center of the air filter 130. The outer perimeter 220 includes a first side portion 226, a second side portion 228, a first end portion 230, and a second end portion 232. In some embodiments, as illustrated, the first side 226 and the second side 228 extend for a distance 234 between the first end portion 230 and the second end portion 232 (e.g., length) that is greater than the distance 237 (e.g. width) between the first side 226 and the second side 228. The first side 226 and the second side 228 are straight and the first end portion 230 and the second end portion 232 are curvilinear (e.g., semi-circular as illustrated). In other embodiments, the outer perimeter 220 of the base 214 has a different shape (e.g., square, rectangle, other polygon, circle, oval, ellipse, etc.). In the illustrated embodiment, the length 234 of the outer perimeter 220 of the bottom 196 is equal to the length 210 of the top 194 and the width 237 of the outer perimeter 220 of the bottom 196 is equal to the width 212 of the top 194.

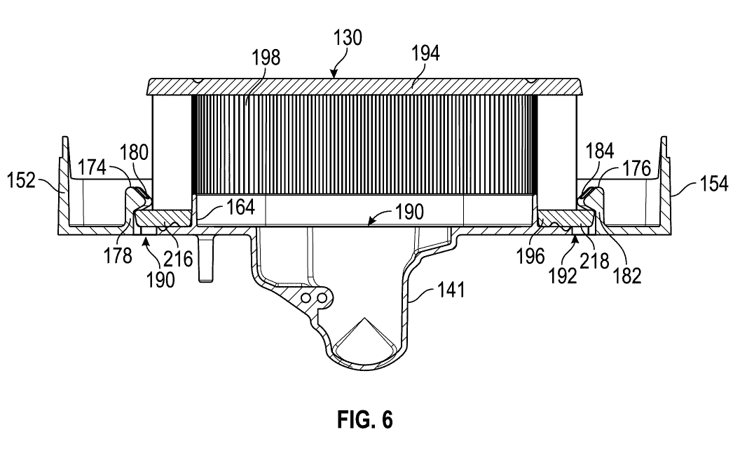

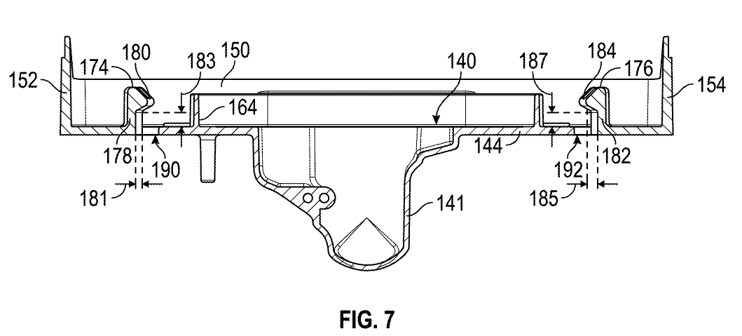

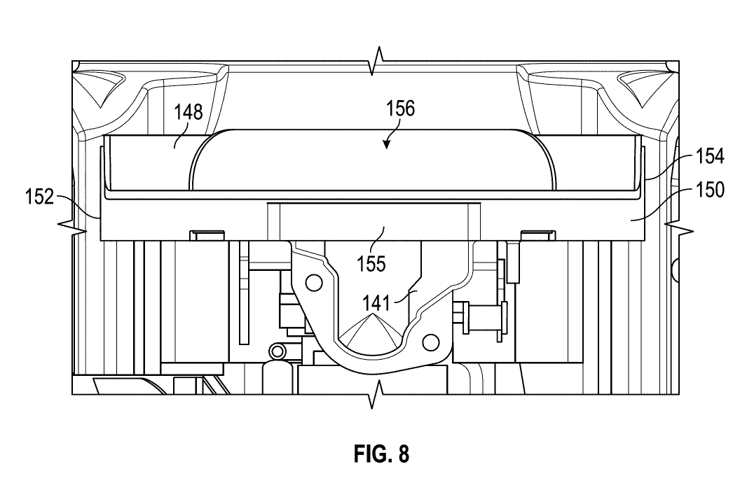

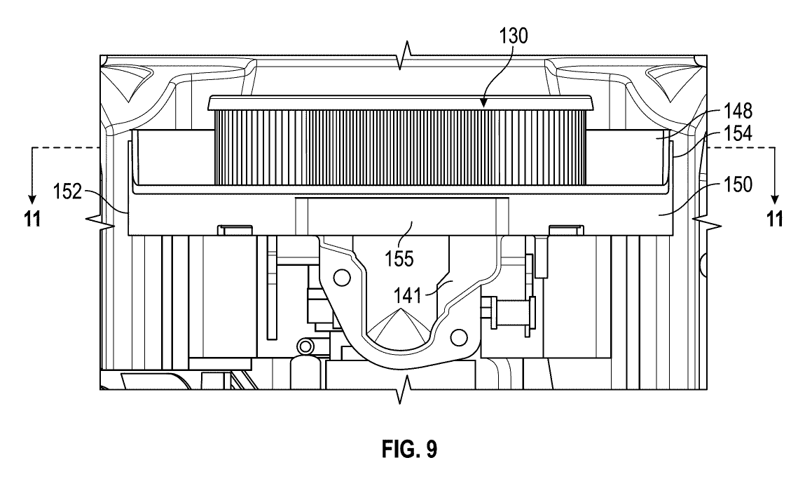

The inner perimeter 222 defines an opening or aperture 235 that allows filtered air to exit the air filter 130. The inner perimeter includes a first side portion 236, a second side portion 238, a first end portion 240, and a second end portion 242. In some embodiments, as illustrated, the first side 236 and the second side 238 extend for a distance 244 between the first end portion 240 and the second end portion 242 (e.g., length) that is greater than the distance 246 (e.g. width) between the first side 236 and the second side 238. The first side 236 and the second side 238 are straight and the first end portion 240 and the second end portion 242 are curvilinear (e.g., semi-circular as illustrated). In other embodiments, the inner perimeter 222 of the base 214 has a different shape (e.g., square, rectangle, other polygon, circle, oval, ellipse, etc.). The opening 235 is sized and shaped to receive the protrusion 164 of the base 134 to help secure the air filter 130 to the base 134. As shown in FIG. 6, the protrusion 164 contacts the inner perimeter 222 with a friction fit to attach the air filter 130 to the base 134. A series of transition steps 247 are provided to help seal the bottom 196 to the protrusion 164. In some embodiments, the steps 247 are omitted. The bottom 196 also includes a raised seal 249 and a depressed trough 251 that surround the opening 235. The seal 249 contacts the floor 144 of the base 134 of the air filter housing 132 to help seal the bottom 196 to the floor 144.

The first tab portion 216 extends outward away from the first end portion 230 of the outer perimeter 220. Transitions 248 and 250 delineate between the first tab portion 216 and the base 214. The second tab portion 218 extends outward away from the second end portion 232 of the outer perimeter 220. Transitions 252 and 254 delineate between the second tab portion 218 and the base 214. The transitions 248 and 250 are where the direction of the outer surface of the bottom 196 changes at the first end portion 230 of the outer perimeter 220. The transitions 252 and 254 are where the direction of the outer surface of the bottom 196 changes at the second end portion 232 of the outer perimeter 220. For example, the transition may be the change from a first curvilinear segment or line having a first radius of curvature to a second curvilinear segment or line having a different radius of curvature (as shown in FIG. 15), the transition may be the change from a curved segment or line to a straight segment or line, the transition may be the change from a first straight segment to a second straight segment arranged at an angle to the first straight segment. The transition may be a line (e.g., a straight vertical line) or an area (e.g., a fillet, bevel, or chamfer connecting two segments).

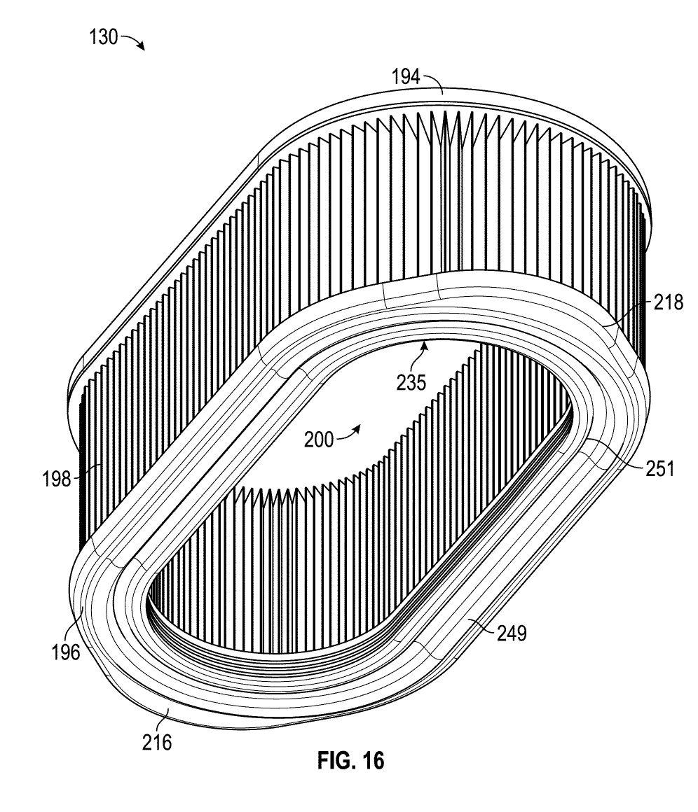

The tab portion 216 has an end portion 256 and the tab portion 218 has an end portion 258. In some embodiments, as illustrated, the end portion 256 of the tab portion 216 is spaced apart from the end portion 258 of the tab portion 218 by a distance 260 (e.g. length) that is greater than the length 234 between the first end portion 230 and the second 232 of the outer perimeter 220. In some embodiments, as illustrated in FIG. 16, the first tab portion 216 extends past the first end portion 206 of the top 194 and the second tab portion 218 extends past the second end portion 208 of the top 194 (i.e., the length 260 is greater than the length 210). In some embodiments, as illustrated in FIG. 15, the outer surface of the 262 of the first tab portion 216 and the outer surface 264 of the second tab portion 218 are curvilinear when viewed from the top as in FIG. 15. In other embodiments, each outer surface may be a combination of curvilinear segments and straight segment or may be a combination of multiple straight segments (e.g., a portion of a rectangle).

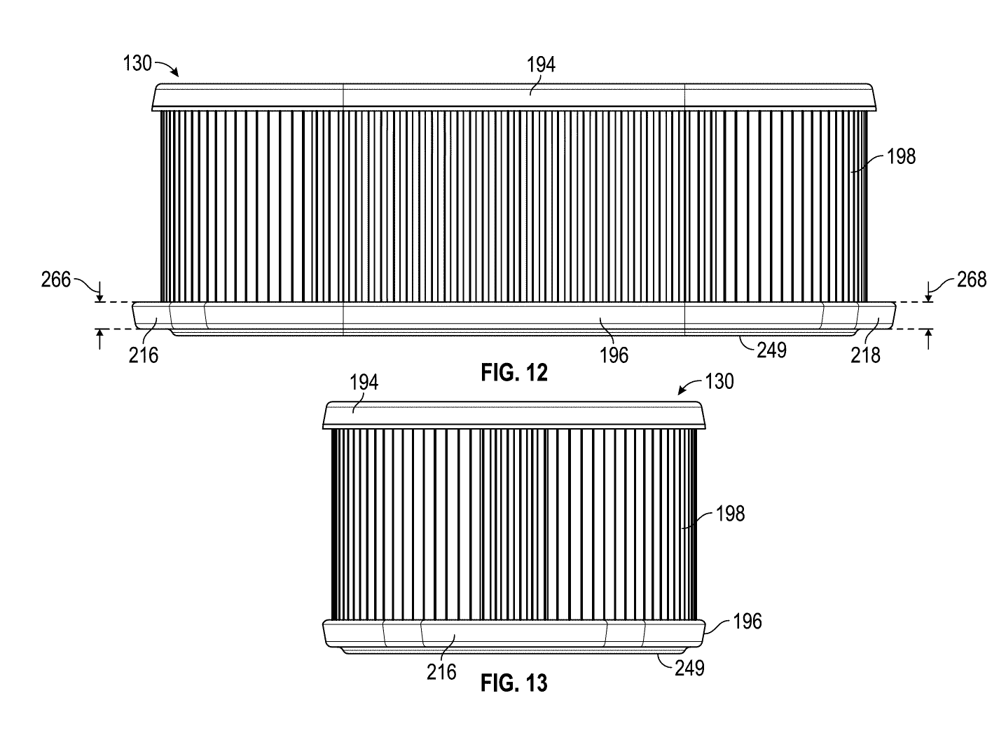

As shown in FIG. 12, in some embodiments, as illustrated, the first tab portion 216 has a thickness or height 266 and the second tab portion 218 has a thickness or height 268. The heights 266 and 268 are substantially the same as the heights of the 183 and 187 of the clamps 174 and 176. As shown in FIG. 6, the upper surfaces of the tab portions 216 and 218 contact at least a portion of the lower surfaces of the fingers 180 and 184, respectively, to attach the air filter 130 to the base 134.

To attach the air filter 130 the base 134, the opening 235 of the bottom 196 is aligned with the protrusion 164 of the base 134 and the filter 130 is pressed down toward the floor 144 of the base 134. The clamps 174 and 176 are flexible relative to the floor 144 to allow movement of clamps 174 and 176 to receive the air filter 130. The clamps 174 and 176 move between an open position in which the bottom 196 of the air filter 130 is able to pass between the clamps 174 and 176 and a closed position in which the clamps 174 and 176 contact the bottom 196 to attach the air filter 130 to the base 134. As shown in FIG. 6, the first tab portion 216 of the bottom 196 is positioned between the finger 180 of the clamp 174 and the floor 144 of the base 134 with the tab portion 216 in contact with both the finger 180 and the base 180 of the clamp 174. Similarly, the second tab portion 218 of the bottom 196 is positioned between the finger 184 of the clamp 176 and the floor 144 of the base 134 with the tab portion 218 in contact with both the finger 184 and the base 182 of the clamp 176. The tab portions 216 and 218 allow the air filter 130 to be attached to the base 134 while keeping the clamps 174 and 176 spaced apart from the filter media 198 as shown in FIG. 6. The clamps 174 and 176 reliably and securely attached the air filter 130 to the base 134 but do not contact the filter media 198, which could damage or otherwise impair the effectiveness of the filter media 198.

The protrusion 164 of the base 134 enters into the opening 235 of the bottom 196 so that the inner perimeter 222 of the bottom 196 contacts the protrusion 164 to form a seal between the bottom 196 and the protrusion 164. The seal 249 of the bottom 196 contacts the floor 144 to form a seal between the bottom 196 and the floor 144. These relationships attach the air filter 130 and the base 134 and form seals between the air filter 130 and the base 134 so that air entering the air filter housing 132 flows through the filter media 198 on its way to the air outlet 140. The air filter 130 is removed from the base 134 by bending the clamps 174 and 176 away from the air filter and pulling the air filter 130 upward off of the protrusion 164.

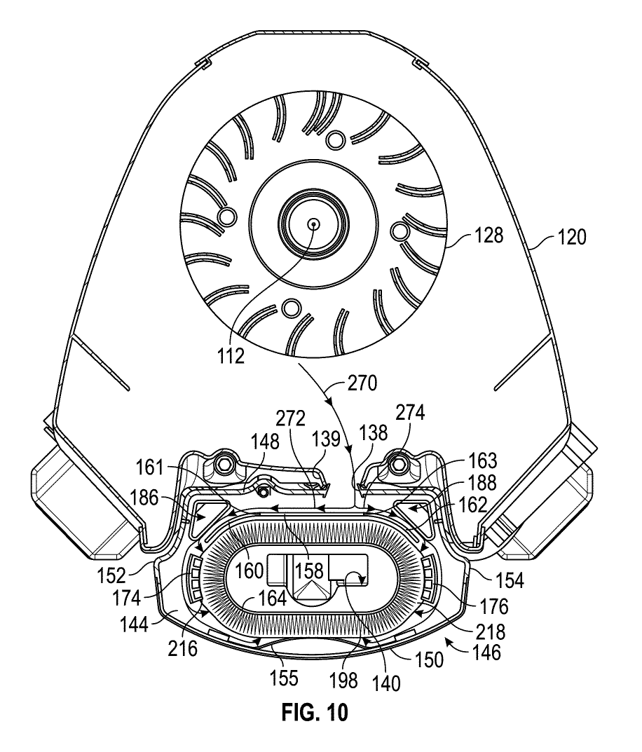

During operation, as the engine 100 is running, ambient or outside air near the engine 100 is drawn into the blower housing 120 as incoming air through the air inlets 126 due to the operation of the blower fan 128. Once inside the blower housing 120, at least some of the incoming air is directed under pressure to the air outlet 140 of the blower housing 120. The incoming air exits the blower housing 120 through the air outlet and enters the air filter housing 132 through the air inlet 138. Airflow in the air filter housing 132 is show with arrows in FIG. 10. The entering incoming air 270 impinges on the wall 156 from a direction that is substantially perpendicular to the central portion 158 of the wall 156. After colliding with the central portion 158 of the wall 156, the entering incoming air 270 is divided into two incoming air flows 272 and 274. The first incoming air flow 272 first travels in a direction substantially parallel to the central portion 158 of the wall and the second incoming air flow 274 first travels in the opposite direction substantially parallel to the central portion 158 of the wall 156. The direction of the first incoming air flow 274 changes as it moves along the wall 156 from the central portion 158 to the end portion 160. As the direction of the first incoming air flow 274 changes to follow the curve or angle of the end portion 160, some of the particulate matter entrained in the incoming air continues in the direction substantially parallel to the central portion 158 toward the opening 186. The particulate matter falls out of the air flow due to a decrease in speed and/or from contact with the outer wall 146 (the rear portion 148 or the left side portion 152) and exits the air filter housing 132 through the opening 186. Similarly, as the direction of the second incoming air flow 276 changes to follow the curve or angle of the end portion 162, some of the particulate matter entrained in the incoming air continues in the direction substantially parallel to the central portion 158 toward the opening 188. The particulate matter falls out of the air flow due to a decrease in speed and/or from contact with the outer wall 146 (the rear portion 148 or the right side portion 154) and exits the air filter housing 132 through the opening 188. The two incoming air flows 274 and 276 continue past the wall 156 and eventually enter the air filter 130 through the filter media 198. The filter media 198 removes additional particular matter from the air flows, resulting in filtered air within the interior chamber 200 of the air filter 130. A filtered air flow exits the interior chamber 200 of the air filter through the air outlet 140 in the floor 144 of the base 134 of the air filter housing 132. The air intake conduit 141 directs the filtered air flow to the carburetor.

The construction and arrangements of the air filter assembly, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention. As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

What is claimed is:

1. An air filter for use with an internal combustion engine including an air intake conduit, comprising:
a top that is closed to prevent air flow therethrough;
a bottom, comprising:
an annular base having an inner perimeter and an outer perimeter spaced apart from and surrounding the inner perimeter,
an opening defined by the inner perimeter to deliver filtered air to the air intake conduit,
a first tab portion extending outward away from the base, and
a second tab portion extending outward away from the base; and
filter media extending between the top and the base to filter incoming air.

2. The air filter of claim 1, wherein the outer perimeter and the inner perimeter are centered about a vertical center axis.

3. The air filter of claim 1, wherein the first tab portion and the second tab portion are located at opposite end portions of the base.

4. The air filter of claim 1, wherein the outer perimeter of the base includes a first side portion, a second side portion, a first end portion, and a second end portion, wherein the first side portion and the second side portion each extend for a length that is greater than the width between the first side portion and the second side portion, and wherein the first tab portion extends outward away from the first end portion and the second tab portion extends outward away from the second end portion.

5. The air filter of claim 4, wherein the first end portion of the outer perimeter is curvilinear and the second end portion of the outer perimeter is curvilinear.

6. The air filter of claim 5, wherein the first tab portion has a curvilinear outer edge and the second tab portion has a curvilinear outer edge.

7. The air filter of claim 5, wherein the first side portion of the outer perimeter is straight and the second side portion of the outer perimeter is straight.

8. The air filter of claim 5, wherein the first end portion of the outer perimeter is semi-circular and the second end portion of the outer perimeter is semi-circular.

9. The air filter of claim 8, wherein the first side portion of the outer perimeter is straight and the second side portion of the outer perimeter is straight.

10. The air filter of claim 5, wherein the first tab portion has a curvilinear outer edge and the second tab portion has a curvilinear outer edge.

11. An air filter for use with an internal combustion engine including an air intake conduit, comprising:
a top that is closed to prevent air flow therethrough;
a bottom including an outer perimeter, a first tab portion extending outward away from the outer perimeter, a second tab portion extending outward away from the outer perimeter, and an opening to deliver filtered air to the air intake conduit; and
filter media extending between the top and the bottom to filter incoming air.

12. The air filter of claim 11, wherein the first tab portion and the second tab portion are located at opposite end portions of the outer perimeter.

13. The air filter of claim 11, wherein the outer perimeter of the bottom includes a first side portion, a second side portion, a first end portion, and a second end portion, wherein the first side portion and the second side portion each extend for a length that is greater than the width between the first side portion and the second side portion, and wherein the first tab portion extends outward away from the first end portion and the second tab portion extends outward away from the second end portion.

14. The air filter of claim 13, wherein the first end portion of the outer perimeter is curvilinear and the second end portion of the outer perimeter is curvilinear.

15. The air filter of claim 14, wherein the first tab portion has a curvilinear outer edge and the second tab portion has a curvilinear outer edge.

16. The air filter of claim 14, wherein the first side portion of the outer perimeter is straight and the second side portion of the outer perimeter is straight.

17. An air filter assembly configured to filter air received from a blower of an internal combustion engine, comprising:
an air filter housing, comprising:
a cover;
a base, wherein the cover and the base define an interior volume, wherein the base includes an air inlet through which a flow incoming air from the blower is configured to enter the interior volume and an air outlet through which a flow of filtered air is configured to exit the interior volume;
a plurality of debris openings formed through the base; and
a deflector positioned between the air inlet and the air outlet and configured so that the flow of incoming air impinges on the deflector and the deflector directs the flow of incoming air toward the debris openings to allow particulate matter to fall out of the flow of incoming air and exit the interior volume through the debris openings;
an air filter positioned within the interior volume and configured to filter the flow of incoming air to produce the flow filtered air, wherein the air filter includes a top that is closed to prevent air flow therethrough, a bottom including a first outward extending tab portion, a second outward extending tab portion, and an opening configured to deliver the flow of filtered air to the air outlet.

18. The air filter assembly of claim 17, wherein the base further includes a floor and an outer wall extending upward away from the floor, wherein the air inlet is formed through the outer wall and the air outlet is formed through the floor, and wherein the deflector is configured to direct the flow of incoming air toward a first portion of the outer wall and toward a second opposite portion of the outer wall.

19. The air filter assembly of claim 18, wherein the deflector includes a central portion arranged so that the flow of incoming air impinges on the central portion from a direction that is substantially perpendicular to the central portion and is divided into a first flow of incoming air configured to travel in a first direction substantially parallel to the central portion and toward a first of the debris openings and in an opposite second direction substantially parallel to the central portion and toward a second of the debris openings.

20. The air filter assembly of claim 19, wherein the deflector includes a first outer portion that is not parallel to the central portion and configured to direct the first flow of incoming air in a third direction not parallel to the central portion to cause particulate matter to fall out of the first flow of incoming air and exit the interior volume through the first debris opening; and
wherein the deflector includes a second outer portion that is not parallel to the central portion and configured to direct the second flow of incoming air in a fourth direction not parallel to the central portion to cause particulate matter to fall out of the second flow of incoming air and exit the interior volume through the second debris opening.

21. An air filter assembly configured to filter air received from a blower of an internal combustion engine including an air intake conduit, comprising:
an air filter housing, comprising:
a cover;
a base, wherein the cover and the base define an interior volume, wherein the base includes an air inlet through which incoming air from the blower is configured to enter the interior volume and an air outlet through which filtered air is configured to exit the interior volume;
a first clamp; and
a second clamp; and
an air filter positioned within the interior volume and configured to filter the incoming air to produce filtered air, wherein the air filter includes a top that is closed to prevent air flow therethrough, a bottom including a first outward extending tab portion, a second outward extending tab portion, and an opening configured to deliver filtered air to the air outlet;
wherein the first clamp contacts the first outward extending tab portion and the second clamp contacts the second outward extending tab portion to at least partially attach the air filter to the base.

22. The air filter assembly of claim 21, wherein the base further includes a floor and wherein the first clamp includes a first base extending upward away from the floor and a first finger extending away from the first base to form a first space, wherein the second clamp includes a second base extending upward away from the floor and a second finger extending away from the second base to form a second space, wherein the first outward extending tab portion of the air filter is positioned within the first space and the second outward extending tab portion of the air filter is positioned within the second space.

23. The air filter assembly of claim 22, further comprising:
a plurality of debris openings formed through the floor; and
a deflector positioned between the air inlet and the air outlet and configured so that the incoming air impinges on the deflector and the deflector directs the incoming air toward the debris openings to allow particulate matter to fall out of the flow of incoming air and exit the interior volume through the debris openings.
